(19) United States
(12) Patent Application Publication
(10) Pub. No.: US 2006/0061068 A1
(43) Pub. Date: Mar. 23, 2006

(54) Dab vibration damper

(76) Inventors: Krista Nash, Ogden, UT (US); Alan Ward, North Ogden, UT (US); Mark Bunker, Ogden, UT (US); Jeff Morley, Hooper, UT (US); Merle K. Ricks, Layton, UT (US)

Correspondence Address: Sally J. Brown;AUTOLIV ASP, INC., 3350 Airport Road, Ogden, UT, 84405, US

(21) Appl. No.: 10/945,062

(22) Filed: Sep. 20, 2004

(51) Int. Cl. B60R 21/16

(52) U.S. Cl. 280/728.2

(57) ABSTRACT

A vibration damper gasket is provided for a vibration damper gasket mounting an airbag inflator within an airbag module such that the airbag inflator may serve as a vibration damper for the vehicle. The vibration damper gaskets include a mounting ring sized and designed to fit about the edge of an airbag inflator flange. The mounting ring generally includes upper and lower retention arms and an adapter groove positioned between the retention arms for receiving the edge of the airbag inflator flange. The mounting ring also has a compression column provided on an outside surface of the mounting ring to allow the gasket to be compression-mounted within a vehicle. The vibration damper gaskets of the invention additionally include at least one inflator ground extending along an inside surface of the mounting ring from at least an upper contact surface of the upper retention arm continuously across the adapter groove to a lower contact surface of the lower retention arm. This inflator ground serves to ground the airbag inflator and prevent unintentional initiation of the inflator which may be caused by built-up electrical charges.

### BACKGROUND OF THE INVENTION

During the operation of a motor vehicle, the driver may often experience vibrations transmitted through the steering wheel of the vehicle. Such vibrations may commonly be caused by situations such as a poor road surface, improper alignment or adjustment of the vehicle tires, or other mechanical conditions. This vibrational feedback does not generally present a hazard to the driver of the vehicle. In some situations however, vibration may render steering the vehicle difficult, and lower the driver's ability to control the vehicle. In addition, vibrations received through the steering wheel may become distracting to the driver, and thus may prevent the vehicle driver from noticing other hazards on the road or from otherwise properly focusing their attention on the task of driving. Such conditions may increase the likelihood of a vehicle accident.

Modern steering wheels and steering columns are often constructed using a vibrational damper to reduce the amount of steering wheel vibration experienced by a driver. Known dampers include a mass of metal mounted within the steering column in such a way that it is allowed to oscillate or move to absorb some of the vibrations transmitted through the steering column. This mass of metal or “attenuation mass” is generally mounted to the steering column by an elastic member which allows it to move as described. When vibration is passed to the steering column, it is passed to the “attenuation mass” which operates to dampen the vibration passed through the steering wheel to the driver.

Recently, there has been a movement in the airbag module industry to utilize already existing components of the steering wheel and/or steering column as the attenuation mass for a vibration damper system. One suitable mass is the inflator of an airbag module. In order to use the inflator of an airbag module as the attenuation mass, the inflator must be mounted within the airbag module in such a way that it is permitted to vibrate or move in response to vibrations transmitted to the inflator through the steering column. When properly mounted, air bag inflators function very similarly to the attenuation mass previously used in such vibration damper systems. This also results in an overall reduction of components within a steering wheel and steering column assembly and thus may reduce the cost required for this portion of the vehicle.

Several challenges have been faced in using an airbag inflator as an attenuation mass provided to dampen vibrations in the steering column. Once such difficulty is providing a proper mounting for the inflator that will hold the inflator in place during both storage and operation of the airbag module that properly allows movement of the inflator to dampen the vibrations. Several solutions to this problem have been provided, but engineers have been additionally faced by the challenge of properly grounding the inflator module so as to prevent accidental, improper, or unintended activation of the inflator by the presence or buildup of electrical charges such as those provided by static electricity, lightning or other sources. Without proper grounding, such electrical sources could trigger initiation of the inflator, deploying an air bag in an unexpected and potentially dangerous fashion.

Grounding has been provided by running a grounding wire from the inflator to another metal portion of the steering wheel or steering column. This solution is problematic in that because the inflator's use as a attenuation mass, it will vibrate, subjecting the wire to wear, repetitive movement, and strain that may result in breakage of the wire, damage to the inflator, or simply improper grounding. This could be dangerous for the reasons outlined above.

As a result, it would be a benefit in the art to provide a structure for mounting an airbag inflator in a vehicular steering wheel/steering column assembly for use as an attenuation mass that allows the inflator to vibrate in response to the steering column, while also permitting the inflator to be properly and durably grounded. Such a device, airbag modules incorporating such a device, methods of their use, and steering wheels incorporating such a device are disclosed herein.

### BRIEF SUMMARY OF THE INVENTION

The apparatus of the present invention has been developed in response to the present state of the art, and in particular, in response to the problems and needs in the art that have not yet been fully solved by currently available systems for damping vibration in steering columns. Thus, the present invention provides a novel mounting structure for an airbag inflator that allows the inflator to be used as a damper for vibrations transmitted through the steering column of a vehicle.

In a first embodiment, the invention provides a vibration damper gasket for use in an inflatable airbag module mounted in the steering column of a vehicle. The vibration damper gasket of the invention includes a mounting ring sized, shaped, and configured to fit about the edge of the flange of an airbag inflator. The mounting ring has upper and lower retention arms and an adapter groove positioned between the retention arms. The adapter groove is sized to receive the edge of the airbag inflator flange. The retention arms and adapter groove are supported by a compression column provided on an outside surface of the mounting ring. The vibration damper gasket further includes an inflator ground extending along an inside surface of the mounting ring from at least an upper contact surface of the upper retention arm continuously across the adapter groove to a lower contact surface of the lower retention arm. The inflator ground serves to ground the airbag inflator within the steering column assembly.

In a first configuration, the vibration damper gasket may include a mounting ring produced as a monolithic elastomeric ring. In producing the monolithic mounting ring, the adapter groove is sized to accommodate the edge of an airbag inflator flange. In some instances, the adapter groove of the vibration damper gasket is sized to be slightly smaller than the edge of an airbag inflator flange. In others, the adapter groove of the vibration damper gasket is sized to be approximately identical in size to the edge of an inflator flange. In still others, the adapter groove of the vibration damper gasket is sized to be slightly larger in size than the edge of an inflator flange.

These various sizing schemes of the adapter groove regulate the method of attachment of the gasket to the inflator. More specifically, close conformity in size of the groove to the size of the inflator flange regulates the tightness of the fit of the flange into the groove. In some situations, the tightness and depth of the groove may be sufficient to retain the inflator within the gasket alone. In others, it may be desirable to include an adhesive to assure proper retention of the inflator within the gasket. Indeed, it may be desirable to use an adhesive even when a tight fit is provided. A conductive adhesive may be used to help assure proper grounding of the inflator.

In another configuration of the vibration damper gaskets of the invention, the gaskets include non-monolithic mounting rings and a ground. More specifically, the mounting ring is composed of a stacked set of rings, each with a specific size and purpose. The mounting ring thus includes a first elastomeric ring having a module plate contact surface, an inflator flange support surface, and an adapter interface surface. This ring rests on the module plate and serves as a support for the mounting ring. The mounting ring next includes an elastomeric adapter ring having an interior diameter adapted to conform to the edge of the airbag inflator flange. This adapter ring is placed atop the first elastomeric ring. The mounting ring finally includes a second elastomeric ring having a contour plate contact surface, an inflator flange support surface, and an adapter interface surface. This ring is placed atop the adapter ring and is the structure that has direct contact with the contour plate of the airbag module.

In yet another configuration, the mounting ring of the vibration damper gaskets of the invention may take the form of a strip configured to be wrapped about the flange of the airbag inflator. The strip includes upper and lower retention arms and an adapter groove positioned between the retention arms for receiving the edge of the airbag inflator flange. The retention arms and adapter groove of the strip are supported by a compression column provided on an outside surface of the mounting ring. In use, the strip making up the mounting ring of the gasket is wrapped about an inflator and cut to size to accurately accommodate the inflator. The use of a strip allows free accommodation of the vibration damper gasket to a wide variety of inflators with varying sizes, flange sizes, flange shapes, and flange geometries.

In some instances, the ends of the strip of the vibration damper gasket produced by cutting the strip to size may be attached to each other. This may be accomplished using an adhesive, a fastener, a clamp, or other method or structure known to one of ordinary skill in the art. In some instances, it may be useful to affix the ends to each other using a conductive adhesive.

Each of the vibration damper gaskets of the invention include an inflator ground to assure proper grounding of the airbag inflator, thus preventing unintended deployment resulting from the buildup of an electrical charge, lightning strike, etc. The inflator ground is a conductive layer placed on exterior surfaces of the mounting gasket which may be selected from the group consisting of metal braid, metal wire, metal foil, or carbon fiber. The inflator ground travels from at least a point on an upper surface that is in contact with, or when installed will contact the contour plate, then travel across an interior face of the gasket to a bottom surface that is in contact with, or when installed, will contact the module plate of the airbag module. The ground thus appears to be a strip across a portion of the gasket. The inflator ground may be varied to have different forms, such as rings completely traversing the gasket, or the entire gasket may be ensheathed by the ground. In some instances, the vibration damper gasket may include a plurality of inflator grounds. In specific configurations, the gasket includes at least two inflator grounds.

The vibration damper gaskets of the invention are intended for use with inflatable airbag modules having airbag inflators. Each of the gaskets of the invention is configured to be mounted in a vehicle primarily by compression between a contoured plate and a module plate. Each gasket of the invention has a support column for this purpose. More specifically, the gaskets are constructed to have a support column having a height sufficient to provide a secure fit when the gasket is clamped between the contour and module plates. A secure fit may be provided by adapting the support column of the gasket to have a height either substantially equal to or slightly larger than the height of the space defined between the contoured plate and the module plate when they are attached together. When placed between the contoured and module plates, with the plates attached, the elastomeric nature of the gasket allows it to slightly deform, and its tendency to return to its natural shape provides the pressure needed to hold the inflator in place.

In some configurations, it may be sufficient to provide a vibration damper gasket with a support column slightly smaller than the height of the space defined between the contoured plate and the module plate when they are attached together. This may be the case when either or both of the contour and module plates are provided with surface features that protrude to engage the gasket and retain it in place.

The gasket may be supplementally attached to the contoured plate and/or the module plate using an adhesive such as a conductive adhesive. This may provide additional integrity to the mounted vibration damper gasket, and potentially aid in preventing shifting of the gasket during operation of the vehicle.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a cross-sectional view of an airbag module with an airbag inflator mounted within the airbag module using a vibration damper gasket of the invention such that the airbag inflator can serve as vibration dampening mass for the steering column of a vehicle into which it is installed;

FIG. 2 is an isolated perspective view of the vibration damper gasket illustrated in FIG. 1;

FIG. 3 is a cross-sectional view of an airbag module with an airbag inflator mounted within the airbag module using a second embodiment of the vibration damper gaskets of the invention such that the airbag inflator can serve as a vibration dampening mass for the steering column of a vehicle into which it is installed;

FIG. 4A is an isolated perspective view of still another vibration damper gasket of the invention; and

FIG. 4B is an isolated perspective view of the vibration damper gasket of FIG. 4A installed about an airbag inflator.

### DETAILED DESCRIPTION OF THE INVENTION

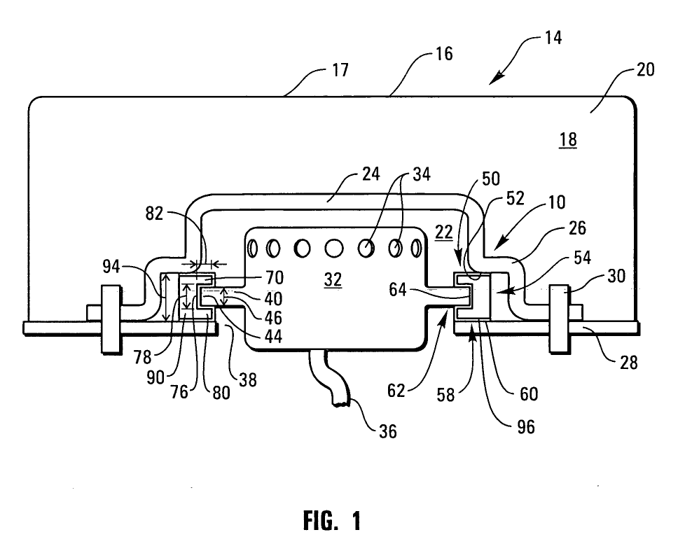

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the vibration damper gasket of the present invention, as represented in FIGS. 1 through 4A, is not intended to limit the scope of the invention, as claimed, but is merely representative of presently preferred embodiments of the invention.

Referring first to FIG. 1, a cross-sectional view of an airbag module 14 is shown. In FIG. 1, the airbag inflator 32 is illustrated mounted within the airbag module 14 using a vibration damper gasket 10 of the invention. The vibration damper gaskets 10 of the invention securely attach the inflator 32 to the airbag module 14 while allowing the inflator 32 to oscillate in response to transmitted forces, thus allowing the mass of the airbag inflator 32 to be used to dampen the force before it is transmitted through a steering column to a vehicle operator.

The airbag module 14 of FIG. 1 generally includes an external housing 16 and a module plate 28 which cooperate to define a cavity 18. The cavity 18 is filled in part with an airbag cushion 20 configured to escape through the housing at a frangible seam or other similar structure known to one of ordinary skill in the art. In use, the airbag module 14 is positioned atop a steering column in a steering wheel of a vehicle such that the airbag cushion 20 will be deployed between the steering column and a vehicle operator.

The cavity 18 of the airbag module 14 further includes a sub-divided inflator cavity 22 separated from the primary cavity 18 by a contour plate 24. The contour plate 24 is designed to be mounted to the module plate 28 and subdivide the primary cavity 18 to enclose an airbag inflator 32. The contour plate 24 also serves to secure the airbag inflator 32 to the vehicle using the inflator gaskets 10 of the invention, as will be discussed in greater detail below.

The airbag inflator 32 is mounted within the inflator cavity 22 of the module 14 so as to allow some movement of the inflator 32 to dampen vibrational energy transmitted through the steering column. More specifically, in the modules 14 of the invention, the inflator 32 is mounted using a vibration damper gasket 10, which suspends the inflator 32 within the inflator cavity 22. The inflator cavity 22 discussed above is defined by the contour plate 24 and the module plate 28. The inflator cavity 22 generally encompasses the airbag inflator 32, which is generally suspended within the cavity 22. The contour plate 24 provides clearance above the inflator 32 to allow movement, while the module plate 28 below the inflator 32 has an orifice 38 to provide clearance below the inflator 32. The inflator orifice 38 generally accommodates protrusion of the body of the inflator 32 from the module 14, but is sufficiently narrow to prevent passage of the inflator flanges 40 through the orifice 38. Thus, the inflator cavity 22 generally provides sufficient clearance to allow movement of the inflator 32 in response to force transmitted to it through a steering column to which the module 14 has been mounted. The inflator orifice 38 is also sufficient in size to allow passage of the electrical connections 36 used to connect the inflator 32 to an accelerometer and/or other associated apparatus commonly used in the art to detect a collision event and trigger initiation of the inflator 32 and deployment of the airbag cushion 20. As described above, the orifice 38 is still small enough to prevent escape of the inflator 32 through the orifice 38.

The vibration damper gasket 10 of FIG. 1 is used to mount the airbag inflator 32 to the module 14. The gasket 10 fit about a lateral radial flange 40 of the inflator 32 in such a manner that the inflator 32 may be securely supported solely by the gasket 10. Thus, the gasket 10 is generally an elastomeric ring configured to fit about an outer edge 44 of the radial flange 40 of an airbag inflator 32. As such, it may be adapted in size and shape to fit about a particular inflator 32. Use of suitable elastomeric materials in preparing the gasket 10 also provides some flexibility in accommodating a variety of flange shapes with a single gasket 10 design. In some instances, the flange 40 is generally circular in shape. In others, it is substantially parallellogrammatic in shape with rounded comers. The gaskets 10 of the invention may be varied widely to accommodate a broad spectrum of inflator 32 designs and shapes, with the size, scale, and depth of the gasket 10 being modified to provide adequate support for the airbag inflator 32 in each instance.

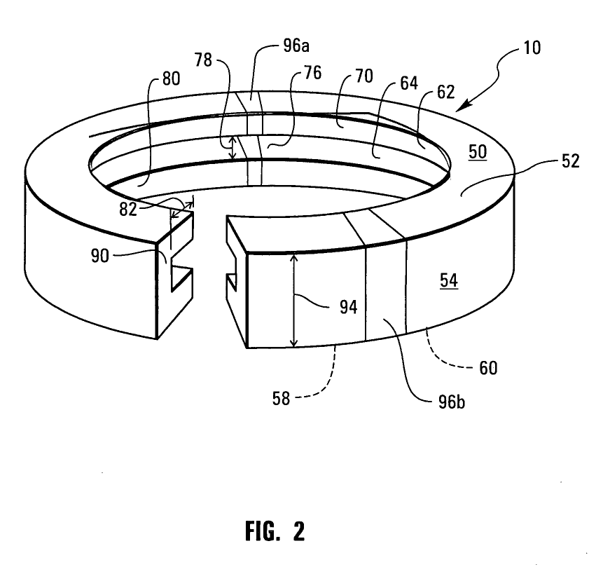

In the embodiment of the gaskets of the invention illustrated in FIGS. 1 and 2, the gasket 10 is a monolithic elastomeric ring. The gasket 10 generally includes upper and lower arms 70, 80, respectively, which each encompass a portion of the edge 44 of the radial inflator flange 40. The inflator flange 40 is housed in the gasket 10 within a groove 76 defined by the upper and lower arms 70, 80. The depth 82 of the groove 76 is adapted to provide arms 70, 80 sufficient to adequately support the mass of the inflator 32.

The width 78 of the groove 76 is determined so as to provide a secure fit to the airbag inflator 32. More specifically, the groove 76 may have a width 78 slightly smaller than a width 46 of the edge 44 of the inflator flange 40. The elastomeric arms 70, 80 may flex slightly and grasp the flange 40 to allow the edge 44 to penetrate sufficiently into the groove 76 to provide a secure fit. Alternatively, the groove 76 may have a width 78 equivalent to the width 46 of the edge 44 of the inflator flange 40 or slightly larger than the width 46 of the edge 44 of the inflator flange 40. In either of these cases, the depth 82 of the groove 76 may be adapted to be sufficient to allow secure retention of the inflator 32, and/or an additional adhesive may be used to secure the inflator 32 in place within the gasket 10.

The gasket 10 further includes a compression column 90 supporting the arms 70, 80 and defining an inner surface of the groove 76. In the embodiment of the gaskets 10 of the invention illustrated in FIG. 1, the compression column 90 is continuous with the arms 70, 80. The compression column 90 is adapted to be placed within a portion of the inflator cavity 22 defined by a gasket adapter step 26 of the contour plate 24. More specifically, the compression column 90 has a height 94 provided to allow the contour plate 24 to engage the compression column 90 when the contour plate 94 is attached to the module plate 28. Such engagement generally occurs at a contact surface 52 of the upper surface 50 of the gasket 10, as well as at a contact surface 60 of the lower surface 58 of the gasket 10. The contour plate 24 may also optionally contact a rear surface 54 of the gasket 10, but is generally clear of the inner surface 62 of the gasket 10.

As illustrated in FIG. 1, the upper contact surface 52 of the gasket is generally smaller than the lower contact surface 60 of the gasket 10. More specifically, the lower contact surface 60 is illustrated to extend from the compression column 90 along the lower arm 80 of the gasket 10, supporting the lower arm 80 from beneath. This is so because the inner diameter of the gasket 10 is adapted to conform to the diameter of the inflator orifice 38. This allows the gasket 10 to provide greater support for the inflator 32 from below the inflator 32 to support it against gravity. The inflator 32 is thus given greater ability to move upwardly against the upper arm 70 of the gasket 10.

The gasket 10 further includes an inflator ground 96 illustrated here as a continuous conductive layer applied about the outer surfaces of the gasket 10. Each of the vibration damper gaskets 10 of the invention include at least one such inflator ground 96 to assure proper grounding of the airbag inflator 32. The inflator ground 96 is a conductive layer placed on the exterior surface of the mounting gasket 10. Suitable materials used to make such a ground 96 may be selected from the group consisting of metal braid, metal wire, metal foil, or carbon fiber. Suitable materials may be attached to the gasket 10 using adhesives or other suitable means known to one of ordinary skill in the art.

In the gaskets 10 of the invention, the inflator ground 96 travels from at least a point on the contact surface 52 of the upper surface 50 of the gasket 10 across the inner surface 62 and its contact surface 64, and to the lower contact surface 60 of the lower surface 58. The ground 96 may also span the rear surface 54. The ground 96 is configured such that when installed, it is at least in contact with the contour plate 24, the inflator flange 40, and the module plate 28. The ground 96 may thus appear as a strip across a portion of the gasket 10. The inflator ground 96 may be varied to have different forms, such as rings completely traversing the gasket, or the entire gasket 10 may be ensheathed by the ground 96. The number and placement of the grounds 96 may also be varied within the scope of the invention. In some instances, the vibration damper gasket 10 may include a plurality of inflator grounds 96. In specific configurations, the gasket 10 includes at least two inflator grounds 96.

Referring next to FIG. 2, an isolated perspective view of the vibration damper gasket 10 illustrated in FIG. 1 is shown. More specifically, the vibration damper gasket 10 is shown removed from the airbag module 14 of FIG. 1. As described previously, the gasket 10 is a monolithic elastomeric structure. In this particular embodiment of the gasket 10, it is shown to be substantially circular in shape to fit about a substantially circular inflator flange. The general shape of the gasket 10 may be easily varied to accommodate a wide variety of inflator flange shapes and sizes. As described above, the gasket 10 includes an upper arm 70, a groove 76, and a lower arm 80. A support column 90 unites the upper and lower arms 70, 80 of the gasket 10. The gasket 10 has an upper surface 50, a lower surface 58, an inner surface 62, and a rear surface 54. As above, the upper surface 50 has a contact surface 52, and the lower surface 58 has a contact surface 60. The groove 76 has a width 78 and a depth 82 configured to grasp the flange of an airbag inflator. The gasket 10 further includes a pair of inflator grounds 96a, 96b viewed here as rings encircling the surfaces 50, 54, 58, 62 of the gasket 10.

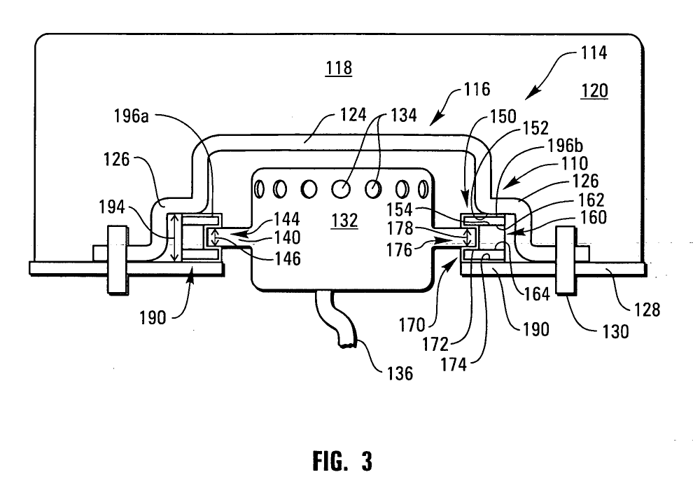

FIG. 3 is a cross-sectional view of an airbag module 114 including an airbag inflator 132 mounted within the airbag module 114 using a second embodiment of the vibration damper gaskets 110 of the invention. As with the embodiment illustrated in FIGS. 1 and 2, the vibration damper gasket 110 allows the airbag inflator 132 to serve as a vibration dampening mass for the steering column of a vehicle into which the module 114 may be installed. In this embodiment, however, the gasket 110 is not a unitary, monolithic mass, but is instead composed of a set of components that cooperate to form the final gasket 110.

As in the airbag module 14 described in FIG. 1, the airbag module 114 of FIG. 3 the airbag inflator 132 is illustrated as being suspended within the airbag module 114. In FIG. 3, the inflator 132 is mounted using a second embodiment of the vibration damper gasket 110 of the invention. As with the vibration damper gasket 10 of FIGS. 1 and 2, the vibration damper gasket 110 of the invention securely attaches the inflator 132 to the airbag module 114 while allowing the inflator 132 to oscillate in response to transmitted forces. In this way, the mass of the airbag inflator 132 is used to dampen the force before it is transmitted through a steering column to a vehicle operator. Unlike the monolithic gasket 10 of FIGS. 1 and 2, the gasket 110 of FIG. 3 is a composite structure made up of independent, stacked rings 150, 160, 170. These rings 150, 160, 170 are combined and locked between the contour plate 124 and the module plate 128 to secure the inflator 132. These features will be discussed in greater detail below.

The airbag module 114 of FIG. 3 generally includes an external housing 116 and a module plate 128 which cooperate to define a primary module cavity 118. The cavity 118 is filled in part with an airbag cushion 120 configured to escape through the housing at a frangible seam 117 or other similar structure known to one of ordinary skill in the art. In use, the airbag module 114 is positioned atop a steering column in a steering wheel of a vehicle such that the airbag cushion 120 may deploy between the steering column and a vehicle operator to protect the vehicle operator.

The primary module cavity 118 of the airbag module 114 further includes a sub-divided inflator cavity 122 separated from the primary cavity 118 by a contour plate 124. The contour plate 124 is designed to be mounted to the module plate 128 by fasteners 130 and thus, to subdivide the primary cavity 118. This effectively encloses the airbag inflator 132 between the contour plate 124 and the module plate 128, and more specifically, the inflator orifice 138 of the module plate 128. The contour plate 124 also serves to secure the airbag inflator 132 to the vehicle using the inflator gaskets 110 of the invention.

The airbag inflator 132 is mounted within the inflator cavity 122 of the module 114 so as to allow some movement of the inflator 132 to dampen vibrational energy transmitted through the steering column. As in the gasket 10 illustrated in FIGS. 1 and 2, the inflator 132 of FIG. 3 is mounted using a vibration damper gasket 110, which suspends the inflator 132 within the inflator cavity 122. The inflator cavity 122 discussed above is defined by the contour plate 124 and the module plate 128. The contour plate 124 provides clearance above the inflator 132 to allow movement, while the module plate 128 below the inflator 132 has an orifice 138 to provide clearance below the inflator 132. The inflator orifice 138 thus permits protrusion of the inflator 132 from the module 114. Despite this, the orifice 138 is sufficiently narrow to prevent passage of the inflator flange 140 through the orifice 138. The inflator orifice 138 is also sufficient in size to allow passage of the electrical connections 136 used to connect the inflator 132 to components of the module 114 configured to detect a collision event and trigger activation of the module 114.

As discussed above, the vibration damper gasket 110 of FIG. 3 is used to mount the airbag inflator 132 to the module 114. In this instance, the gasket includes three individual rings, 150, 160, 170, more specifically, an upper ring 150, a center ring 160, and a lower ring 170. The upper ring 150 includes an upper surface 152 and a lower surface 154. The upper surface 152 of the upper ring 150 is generally adapted to serve as a contact point for the gasket 110 with the contour plate 124 when the gasket 110 is installed in the inflator module 114. The gasket 110 next includes a center ring 160 having upper and lower surfaces 162, 164. When assembled, the upper surface 162 is in contact with the lower surface 154 of the upper ring 150. The gasket 110 next includes a lower ring 170 having upper and lower surfaces 172, 174. When assembled, the upper surface 172 supports the lower surface 164 of the center ring 160; and the lower surface 174 of the lower ring 170 is in contact with the module plate 128.

The upper and lower rings 150, 170 are generally configured to have an inner circumference (or, in non-circular applications, an inner orifice) similar or equal in size or shape to that of the module plate 128. The center ring 160 has an inner diameter substantially equivalent or slightly larger than that of the inflator flange 140. In this manner, the center ring 160 is sized to fit about a lateral radial flange 140 of the inflator 132 in such a manner that the inflator 132 may be securely supported solely by the gasket 110. The fit of the flange 140 may be adapted by varying the height of the groove 176 defined by the center ring 160. This may be done by varying the height of the center ring 178, and thus of the groove 176. In some configurations, it may be advantageous to provide a groove 176 with a width 178 slightly less than that of the inflator flange 140. Thus, when the flange 140 is inserted into the groove 140, it is grasped by the upper and lower rings 150, 170. Alternatively, the groove 176 may have a width 178 substantially equivalent to, or slightly larger than, the outer diameter/size of the flange 140. In some instances, it may be useful to provide an adhesive to assist in retaining the flange. In some instances, it may be specifically useful to use a conductive adhesive. In this gasket 110, a support column 190 having a height 194 is composed of outer portions of all three of the rings 150, 160, 170.

Thus, the gasket 110 is generally a composite elastomeric ring configured to fit about an outer edge 144 of the radial flange 140 of the airbag inflator 132. The gasket 110 of FIG. 3 is uniquely adaptable in that the rings may be independently varied in size and/or shape to accommodate a wide variety of inflators 132, as well as a wide variety of airbag modules 114. Thus, the size and shape of the upper and lower rings 150, 170 may be tuned to the size and shape of the inflator orifice 138 of the module plate 128, and may be varied in thickness to assure proper compression of the gasket 110 when mounted between the contour plate 124 and the module plate 128. The rings 150, 160, 170 may further include surface features such as interlocking grooves and ridges to stabilize the rings 150, 160, 170 and to retain the rings 150, 160, 170 in their proper orientation.

Use of suitable elastomeric materials in preparing the gasket 110 also provides some flexibility in accommodating a variety of flange shapes with the gasket 110. As with the gasket 10 of FIGS. 1 and 2, the gasket 110 may be customized to accommodate flanges 140 that are generally circular in shape. The gasket 110 may similarly be varied to accommodate a flange 140 that is substantially parallellogrammatic in shape with rounded corners. Indeed, the gaskets 110 of the invention may be varied widely to accommodate a broad spectrum of inflator 132 designs and shapes, with the size, scale, and depth of the gasket 110 being modified to provide adequate support for the airbag inflator 132, and proper mounting of the gasket 110 between the contour plate 124 and module plate 128 in each instance.

As with the previously-discussed embodiment, the vibration damper gasket 110 is configured to house an inflator flange 140 within a groove 176 defined by the upper and lower rings 150, 170. The depth 182 of the groove 176 is adapted to provide sufficient surface area of the upper and lower rings 150, 170 to adequately support the mass of the inflator 132. The width 178 of the groove 176 is determined so as to provide a secure fit to the airbag inflator 132. More specifically, the groove 176 may have a width 178 slightly smaller than a width 146 of the edge 144 of the inflator flange 140. The elastomeric upper and lower rings 150, 170 may flex slightly and grasp the flange 140 to allow the edge 144 to penetrate sufficiently into the groove 176 to provide a secure fit. Alternatively, the groove 176 may have a width 178 equivalent to the width 146 of the edge 144 of the inflator flange 140 or slightly larger than the width 146 of the edge 144 of the inflator flange 140. In either of these cases, the depth 182 of the groove 176 may be adapted to be sufficient to allow secure retention of the inflator 132, and/or an additional adhesive may be used to secure the inflator 132 in place within the gasket 110.

As noted briefly above, the gasket 110 includes a composite compression column 190 comprising portions of the upper, center, and lower rings 150, 160, 170, and defining an inner surface of the groove 176. In the gasket 110 of the invention of FIG. 3, the compression column 190 is adapted to be placed within a portion of the inflator cavity 122 defined by a gasket adapter step 126 of the contour plate 124. The compression column 190 has a height 194 provided to allow the contour plate 124 to engage the compression column 190 when the contour plate 124 is attached to the module plate 128. Such engagement generally occurs at the upper surface 152 of the upper ring 150 of the gasket 110, as well as at a lower surface 174 of the lower ring 170 of the gasket 110.

As illustrated in FIG. 3, the upper surface 152 of the upper ring 150 of the gasket 110 that is in contact with the contour plate 124 is generally smaller than the lower surface 174 of the lower ring 170 of the gasket 110. More specifically, the lower contact surface 174 is illustrated to extend from the compression column 190 along the lower ring 170 of the gasket 110, supporting the gasket 110 from beneath. This is so because the inner diameter of the upper and lower rings 150, 170 of the gasket 110 are adapted to conform to the diameter of the inflator orifice 138. This allows the gasket 110 to provide greater support for the inflator 132 from below the inflator 132 to support it against gravity.

The gasket 110 also includes a pair of inflator grounds 196a, 196b illustrated here as conductive layers applied about the gasket 110. As previously discussed, the inflator grounds 196a, 196b are conductive layers, in this embodiment made as incomplete rings spanning only the upper, inner, and lower surfaces 150, 154, 158 of the gasket 110. Similarly, the materials used to make the grounds 196a, 196b may be selected from the group consisting of metal braid, metal wire, metal foil, or carbon fiber. Suitable materials may be attached to the gasket 110 using adhesives or other suitable means known to one of ordinary skill in the art.

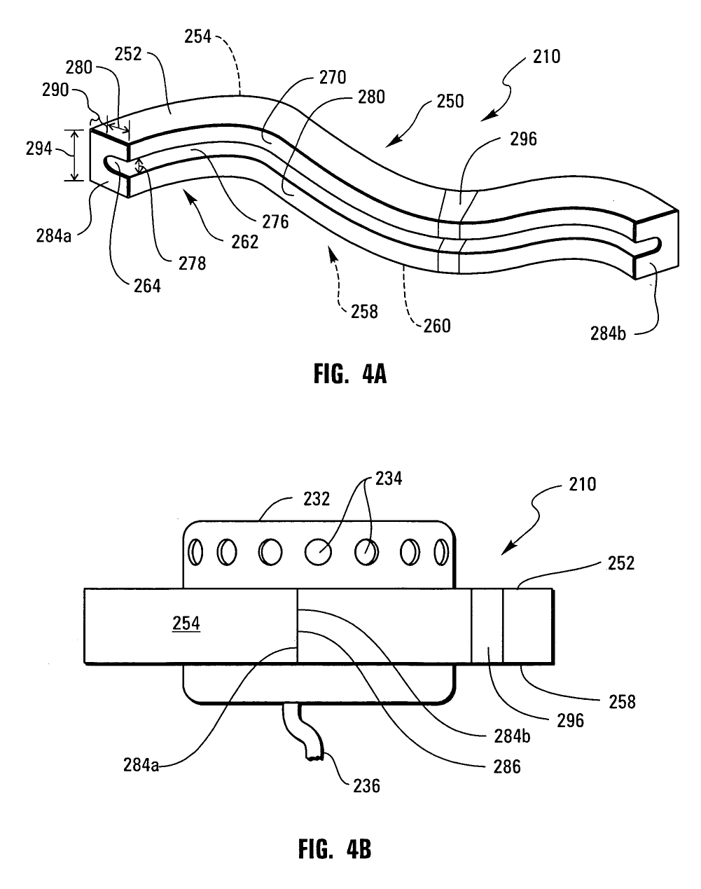

A next embodiment of the invention is illustrated in FIG. 4A. More specifically, an isolated perspective view of still another vibration damper gasket 210 of the invention is shown. The gasket 210 is an elongate strip configured to be wrapped about the edge of an inflator flange as previously discussed with regard to other embodiments of the invention. The gasket 210 includes an upper surface 250 with a contact surface 252, a rear surface 254, a lower surface 258 with a contact surface 260, and an inner surface 262 with a contact surface 264. The gasket 210 further includes an upper arm 270 and a lower arm 280 which surround a groove 276.

As in prior embodiments of the gasket 210, the groove 276 is adapted to be wrapped about an edge of a lateral flange of an airbag inflator (not shown). In this embodiment of the gasket 210, the groove 276 includes a rounded inner contact surface 264 sized and adapted to fit closely about an inflator flange. As in previously discussed embodiments, the groove 276 may be sized to provide a secure fit about the inflator flange. Specifically, the groove 276 may have a depth 282 adapted to provide sufficient surface area in contact with the inflator flange to provide a secure fit. Further, the groove 276 may have a width 278 that is slightly smaller than a width of the inflator flange such that the groove 276 tightly grips the inflator flange. Alternatively, the groove 276 may have a width 278 that is substantially equivalent to the width of the inflator flange, or a width slightly larger than that of the inflator flange. In these two variants, an additional adhesive may be used.

The gasket 210 may further include a compression column 290 sized to have a height adapted to be received and secured into an inflator housing as discussed above with the previous embodiments. Also, as discussed with relation to other gaskets 210 of the invention, the gasket 210 includes an inflator ground 296. In such embodiments of the gaskets 210 of the invention which may be cut-to-size for individual uses, inflator grounds 296 may be placed at intervals (either regular or irregular) along the length of the gasket 210 such that when cut, the gasket includes at least one inflator ground 296. Use of conductive adhesive either in bonding the ends 284a, 284b of the gasket 210 or in attaching the inflator grounds 296 to the gasket 210 may further improve the grounding of the inflator in an airbag module when installed in a vehicle.

FIG. 4B shows an isolated perspective view of the vibration damper gasket 210 of FIG. 4A installed about an airbag inflator 232. As in the previously discussed embodiments, the gasket 210 is installed about the lateral flange of the inflator 232 in a secure fashion to allow the inflator 232 to be installed in an airbag module. In this embodiment of the gaskets 210 of the invention, the strip may be wrapped about flanges of inflators and cut to fit appropriately. This produces ends 284a, 284b which may then be joined together at a seam 286. In some instances a conductive adhesive may be used. The gasket 210 further includes at least one inflator ground 296 in contact with the inflator flange.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A vibration damper gasket for an inflatable airbag module comprising:
a mounting ring configured to fit about the edge of an airbag inflator flange, the ring having upper and lower retention arms and an adapter groove positioned between the retention arms for receiving the edge of the airbag inflator flange, the retention arms and adapter groove being supported by a compression column provided on an outside surface of the mounting ring; and
an inflator ground extending along an inside surface of the mounting ring from at least an upper contact surface of the upper retention arm continuously across the adapter groove to a lower contact surface of the lower retention arm; the inflator ground serving to ground the airbag inflator.

2. The vibration damper gasket of claim 1, wherein the mounting ring is a monolithic elastomeric ring in which the adapter groove is sized to accommodate the edge of an airbag inflator flange.

3. The vibration damper gasket of claim 2, wherein the adapter groove is sized to be slightly smaller than the edge of an airbag inflator flange.

4. The vibration damper gasket of claim 2, wherein the adapter groove is sized to be approximately identical in size to the edge of an inflator flange.

5. The vibration damper gasket of claim 1, wherein the mounting ring includes:
a first elastomeric ring having a module plate contact surface, an inflator flange support surface, and an adapter interface surface;
an elastomeric adapter ring having an interior diameter adapted to conform to the edge of the airbag inflator flange; and
a second elastomeric ring having a contour plate contact surface, an inflator flange support surface, and an adapter interface surface.

6. The vibration damper gasket of claim 1, wherein the mounting ring includes:
a strip configured to be wrapped about the airbag inflator, the strip including upper and lower retention arms and an adapter groove positioned between the retention arms for receiving the edge of the airbag inflator flange, the retention arms and adapter groove being supported by a compression column provided on an outside surface of the mounting ring, wherein the gasket may be wrapped about an inflator and cut to size to accurately accommodate various inflators.

7. The vibration damper gasket of claim 6, wherein the ends of the strip produced by cutting the strip to size are attached to each other.

8. The vibration damper gasket of claim 7, wherein the ends are attached to each other using a conductive adhesive.

9. The vibration damper gasket of claim 1, wherein the inflator ground is an externally-placed conductive layer selected from the group consisting of metal braid, metal wire, metal foil, or carbon fiber.

10. The vibration damper gasket of claim 1, comprising more than one inflator ground.

11. The vibration damper of claim 10, wherein the gasket comprises two inflator grounds.

12. A vibration damper gasket for an inflatable airbag module comprising:
a grooved elastomeric ring having upper, lower, inner, and outer surfaces, with an inflator flange adaptor on the inner face, the inflator flange adaptor being configured to receive and encompass a peripheral edge of a flange of an airbag inflator, the ring being configured to be held in place by compression within an airbag module; and
an inflator ground comprising a layer of conductive material applied in a continuous manner from at least a portion of the upper surface along the inner surface to at least a portion of the lower surface.

13. The vibration damper gasket of claim 12, wherein the elastomeric ring is a monolithic ring in which the adapter groove is sized to accommodate the edge of an airbag inflator flange.

14. The vibration damper gasket of claim 12, wherein the ring is configured to be held in place by compression within an airbag module by adapting the grooved elastomeric ring to have a height substantially equal to the height of an airbag module gasket adapter of the airbag module.

15. The vibration damper gasket of claim 12, wherein the ring is configured to be held in place by compression within an airbag module by adapting the grooved elastomeric ring to have a height slightly larger than the height of an airbag module gasket adapter of the airbag module.

16. The vibration damper gasket of claim 12, wherein the grooved elastomeric ring comprises:
a first elastomeric ring having a module plate contact surface, an inflator flange support surface, and an adapter interface surface;
an elastomeric adapter ring having an interior diameter adapted to conform to the edge of the airbag inflator flange; and
a second elastomeric ring having a contour plate contact surface, an inflator flange support surface, and an adapter interface surface, wherein the damper gasket is assembled by placing the adapter ring between the first and second elastomeric rings in contact with the adapter interface surfaces of the first and second elastomeric rings.

17. The vibration damper gasket of claim 16, wherein the grooved elastomeric ring is configured to be held in place by compression within an airbag module by adapting the first and second elastomeric rings and the elastomeric adapter ring of the grooved elastomeric ring to have a combined height substantially equal to a height of an airbag module gasket adapter of the airbag module.

18. The vibration damper gasket of claim 16, wherein the grooved elastomeric ring is configured to be held in place by compression within an airbag module by adapting the first and second elastomeric rings and the elastomeric adapter ring of the grooved elastomeric ring to have a combined height slightly larger than a height of an airbag module gasket adapter of the airbag module.

19. The vibration damper gasket of claim 12, wherein the grooved elastomeric ring includes:
a strip configured to be wrapped about the airbag inflator, the strip including upper and lower retention arms and an adapter groove positioned between the retention arms for receiving the edge of the airbag inflator flange, the retention arms and adapter groove being supported by a compression column provided on an outside surface of the mounting ring, wherein the gasket may be wrapped about an inflator and cut to size to accurately accommodate various inflators.

20. The vibration damper gasket of claim 19, wherein the ends of the strip produced by cutting the strip to size are attached to each other.

21. The vibration damper gasket of claim 20, wherein the ends are attached to each other using a conductive adhesive.

22. The vibration damper gasket of claim 19, wherein the grooved elastomeric ring is configured to be held in place by compression within an airbag module by adapting the compression column of the grooved elastomeric ring to have a height substantially equal to a height of an airbag module gasket adapter of the airbag module.

23. The vibration damper gasket of claim 19, wherein the grooved elastomeric ring is configured to be held in place by compression within an airbag module by adapting the compression column of the grooved elastomeric ring to have a height slightly larger than a height of an airbag module gasket adapter of the airbag module.

24. The vibration damper gasket of claim 12, wherein the inflator ground is an externally-placed conductive layer selected from the group consisting of metal braid, metal wire, metal foil, or carbon fiber.

25. The vibration damper gasket of claim 24, comprising more than one inflator ground.

26. The vibration damper of claim 25, wherein the gasket comprises two inflator grounds.

27. An airbag module including a vibration damper gasket comprising:
an airbag module plate having an inflator aperture;
an inflator having a lateral radial mounting flange extending from the inflator, the flange having an outside diameter sufficiently large to prevent the passage of the inflator through the inflator aperture of the airbag module plate;
an inflator contour plate configured to be attached to the module plate about the inflator;
a mounting ring configured to fit about the edge of an airbag inflator flange, the ring having upper and lower retention arms and an adapter groove positioned between the retention arms for receiving the edge of the airbag inflator flange, the retention arms and adapter groove being supported by a compression column provided on an outside surface of the mounting ring; and
an inflator ground comprising a conductive film applied to the rings of the module, the film covering at least a portion of the module plate contact surface of the first ring, the adapter ring, and the contour plate contact surface of the second ring.

28. The airbag module of claim 27, wherein the mounting ring is a monolithic elastomeric ring in which the adapter groove is sized to accommodate the edge of an airbag inflator flange.

29. The airbag module of claim 28, wherein the adapter groove is sized to be slightly smaller than the edge of an airbag inflator flange.

30. The airbag module of claim 28, wherein the adapter groove is sized to be approximately identical in size to the edge of an inflator flange.

31. The airbag module of claim 27, wherein the mounting ring is held in place within the airbag module by compression between the inflator contour plate and the airbag module plate.

32. The airbag module of claim 31, wherein the mounting ring is configured to be held in place within the airbag module by compression by adapting the compression column to have a height substantially equal to a height of an airbag module gasket adapter defined by the inflator contour plate and the airbag module plate.

33. The airbag module of claim 31, wherein the mounting ring is configured to be held in place within the airbag module by compression by adapting the compression column to have a height slightly larger than a height of an airbag module gasket adapter defined by the inflator contour plate and the airbag module plate.

34. The airbag module of claim 27, wherein the mounting ring includes:
a first elastomeric ring having a module plate contact surface, an inflator flange support surface, and an adapter interface surface;
an elastomeric adapter ring having an interior diameter adapted to conform to the edge of the airbag inflator flange; and
a second elastomeric ring having a contour plate contact surface, an inflator flange support surface, and an adapter interface surface.

35. The airbag module of claim 34, wherein the mounting ring is held in place within the airbag module by compression between the inflator contour plate and the airbag module plate.

36. The airbag module of claim 35, wherein the mounting ring is configured to be held in place within the airbag module by compression by adapting the first and second elastomeric rings and the elastomeric adapter ring to have a combined height substantially equal to a height of an airbag module gasket adapter defined by the inflator contour plate and the airbag module plate.

37. The airbag module of claim 35, wherein the mounting ring is configured to be held in place within the airbag module by compression by adapting first and second elastomeric rings and the elastomeric adapter ring to have a combined height slightly larger than a height of an airbag module gasket adapter defined by the inflator contour plate and the airbag module plate.

38. The airbag module of claim 27, wherein the mounting ring includes:
a strip configured to be wrapped about the airbag inflator, the strip including upper and lower retention arms and an adapter groove positioned between the retention arms for receiving the edge of the airbag inflator flange, the retention arms and adapter groove being supported by a compression column provided on an outside surface of the mounting ring, wherein the gasket may be wrapped about an inflator and cut to size to accurately accommodate various inflators.

39. The airbag module of claim 38, wherein the ends of the strip produced by cutting the strip to size are attached to each other.

40. The airbag module of claim 39, wherein the ends are attached to each other using a conductive adhesive.

41. The airbag module of claim 38, wherein the inflator ground is an externally-placed conductive layer selected from the group consisting of metal braid, metal wire, metal foil, or carbon fiber.

42. The airbag module of claim 41, comprising more than one inflator ground.

43. The airbag module of claim 42, wherein the gasket comprises two inflator grounds.

44. The airbag module of claim 38, wherein the mounting ring is held in place within the airbag module by compression between the inflator contour plate and the airbag module plate.

45. The airbag module of claim 44, wherein the mounting ring is configured to be held in place within the airbag module by compression by adapting the compression column to have a height substantially equal to a height of an airbag module gasket adapter defined by the inflator contour plate and the airbag module plate.

46. The airbag module of claim 44, wherein the mounting ring is configured to be held in place within the airbag module by compression by adapting the compression column to have a height slightly larger than a height of an airbag module gasket adapter defined by the inflator contour plate and the airbag module plate.
